(19) United States
(12) Patent Application Publication
(10) Pub. No.: US 2005/0201403 A1
(43) Pub. Date: Sep. 15, 2005

(54) Method and apparatus for data transmission in consideration of transmission scheduling

(75) Inventor: Chao Wang, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/074,683

(22) Filed: Mar. 9, 2005

(30) Foreign Application Priority Data
Mar. 15, 2004 (JP) 2004-071905

(51) Int. Cl. H04L 12/28

(52) U.S. Cl. 370/412

(57) ABSTRACT

A transmitting apparatus includes a data generator for segmenting data to be transmitted into pieces of data each having a preselected size, which is determined in accordance with a priority order required of the data to be transmitted as to transmission, and generating data units each containing particular one of the pieces of data. A data transmitter determines a transmission priority order on the basis of the size of the data contained in the data units and transmits the data units in accordance with the priority order.

### BACKGROUND OF THE INVENTION

1. Field of the Invention

The present invention relates to a method of transmitting data to be transmitted between a plurality of terminals and an apparatus for practicing the same. More particularly, the present invention relates to a method of transmitting, e.g., data packets for wireless communication in consideration of transmission scheduling and a wireless communication apparatus using the same. The invention is applicable to a wireless communication apparatus loaded with Bluetooth (trade mark).

2. Description of the Background Art

A multimedia application for use in a system of the kind providing audio, video and other multimedia services processes data relating to sound, voice and video. The prerequisite with this kind of system is the minimum communication delay and the maximum throughput. More specifically, data relating to multimedia or similar particular data in a network must be processed with priority, as has long been recognized in the data communications art. Scheduling, i.e., adequate allotment of system resources is indispensable for providing quality required of such a multimedia service.

The quality of communications services is generally referred to as QoS (Quality of Service). U.S. Pat. No. 5,694,548 to Baugher et al and Japanese patent laid-open publication No. 2000-115240, for example, each disclose a particular technology for guaranteeing QoS. More specifically, the technology taught in the U.S. patent to Baugher et al distinguishes video data, audio data and text data to establish a transmission priority order to thereby guarantee QoS. On the other hand, Japanese publication No. 2000-115240 also mentioned above proposes to readjust the degrees of QoS assigned to different services when resources fall short.

Bluetooth is available as one of wireless communication standards applicable to short-range wireless connections. Even a communication apparatus based on Bluetooth technology transmits and receives, e.g., voice data to and from another apparatus and is therefore sometimes required to guarantee QoS.

A communication apparatus based on Bluetooth technology is generally made up of an upper layer device and a lower layer device referred to as a host and a Bluetooth module, respectively. The host includes, e.g., an application layer belonging to an OSI (Open Systems Interconnection) basic reference model while the Bluetooth module includes a physical layer as well as other layers. The host and Bluetooth module transmit data in the form of data packets, referred to as HCI (Host Controller Interface) data packets. In accordance with the Bluetooth communication standard, the HCI data packets each include data, referred to as a connection handle, identifying another party, or communication apparatus, to communicate with.

The Bluetooth communication standard allows data to be transmitted, which are derived from a plurality of different applications, to and from the same communication apparatus, i.e., a communication apparatus having a connection handle common thereto. At the present stage of development, however, the Bluetooth module cannot use HCI data packets to thereby distinguish an application output data to be dealt with from the other applications. This is because the Bluetooth communication standard requires HCI packets to share a common connection handle that allows the Bluetooth module to identify the other communication apparatus to communicate with. Thus, the Bluetooth module cannot distinguish data packets output from different applications although having the same single connection handle.

To implement services with QoS guarantees, it is necessary to fix a priority order on data packets and preferentially send out data packets of higher priority. However, the Bluetooth communication standard does not allow a Bluetooth module to distinguish data packets having the same connection handle, as stated earlier. Consequently, when data packets of lower priority are being processed, data packets output from a higher-priority application and therefore requiring higher priority cannot be sent out until the end of transmission of the data packets of lower priority. It follows that services with QoS guarantees are difficult to implement when a Bluetooth module deals with a plurality of applications using the same connection handle.

Moreover, the data format of an HCI packet is fixed by the Bluetooth communication standard and cannot be modified by users in such a manner as to distinguish a plurality of applications sharing a connection handle common thereto.

The problems stated above are not particular to communication protocols based on the Bluetooth communication standard, but arise even with communication protocols unable to include data representative of a priority order, e.g., a flag representative of a priority order in packets or similar data units to be sent out.

### SUMMARY OF THE INVENTION

It is an object of the present invention to provide a method of transmitting data to be transmitted between a plurality of terminals, particularly terminals using a communication protocol unable to include data representative of a priority order in a packet or similar data unit to be sent, e.g., wireless communication terminals each including a device based on the Bluetooth communication standard, while realizing services with QoS guarantees and an apparatus for practicing the same.

A method of transmitting data to be transmitted between a plurality of terminals of the present invention begins with the step of segmenting data to be transmitted out into pieces of data each having a preselected size, which is determined in accordance with a priority order required of the data to be transmitted as to transmission, and generating data units each containing particular one of the pieces of data. Subsequently, a priority order as to transmission is determined on the basis of the size of the data contained in the data units. Thereafter, the data units are transmitted in accordance with the above priority order.

An apparatus for practicing the method described above is also disclosed.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a stack of protocols implemented by an embodiment of data transmitting and receiving apparatus applied to a wireless communication apparatus in accordance with the present invention;

FIG. 2 is a schematic block diagram showing a hardware configuration of the illustrative embodiment shown in FIG. 1;

FIG. 3 is a schematic block diagram useful for understanding the flow of data transmitted from one to the other of two wireless communication apparatuses based on the Bluetooth communication standard;

FIG. 4 shows how a logical link control layer implemented by the illustrative embodiment segments an L2CAP data packet into HCI data packets containing the same connection handle;

FIG. 5 is a schematic block diagram useful for understanding how to use a priority and a non-priority transmission buffer available with the illustrative embodiment for data processing; and

FIG. 6 is a flowchart useful for understanding a specific operation of the illustrative embodiment for sending out data stored in the priority and non-priority transmission buffers.

### DESCRIPTION OF THE PREFERRED EMBODIMENT

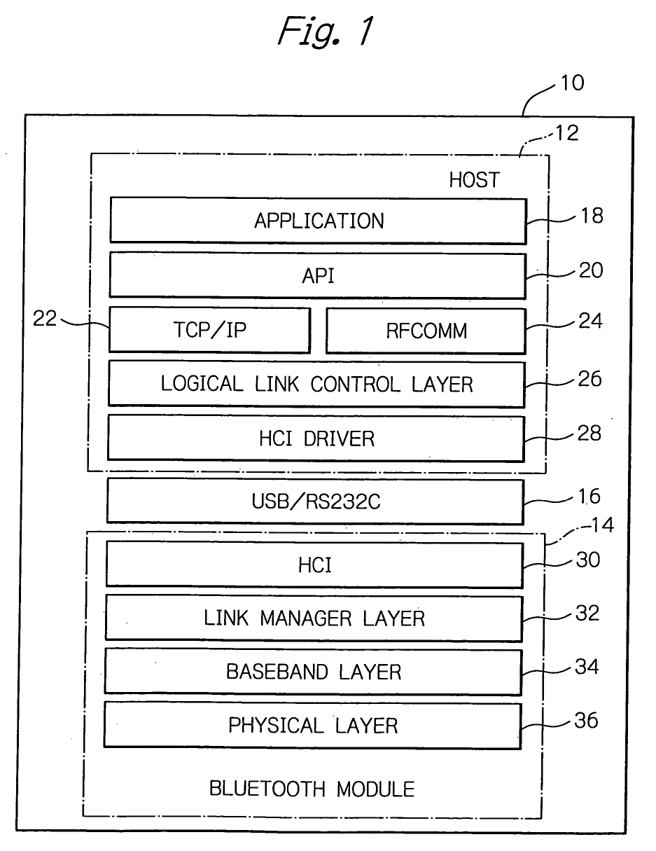

Referring to FIG. 1 of the drawings, a data transmitting and receiving apparatus embodying the present invention is implemented as a wireless communication apparatus using the Bluetooth communication standard by way of example. First, the wireless communication apparatus, generally 10, will be briefly described.

To implement services with QoS guarantees, it is necessary that a Bluetooth module included in the wireless communication apparatus 10 identifies the priority order of data packets output from different applications. In order to allow the Bluetooth module to simply identify the degrees of priority of data packets, with the illustrative embodiment, each HCI data packet has its length particularly defined in accordance with the priority order. For this purpose, use is made of a function available with a logical link control layer (L2CAP: Logical Link Control and Adaptation Protocol) for disassembling an L2CAP data packet received from an application, which is included in a host, into HCI data packets. By that function, data output from different applications each are segmented into data units having a fixed length corresponding to a particular degree of priority.

In the illustrative embodiment, the priority order has two degrees of priority, i.e., high priority and low priority. Data of high priority and needing a guarantee service and data of low priority and not needing it are provided with lengths of 300 bytes and 100 bytes, respectively, by way of example.

Of course, the present invention is practicable with a priority order having any desired number of degrees of priority other than two degrees mentioned above. Also, 300 bytes and 100 bytes, which are respectively the lengths of high-priority and low-priority data, are only illustrative and may be replaced with any desired numbers of bytes so long as they lie in a range allowable in accordance with the Bluetooth communication standard. Further, the sizes of the data lengths may not be fixed. For example, high priority and low priority may be given to data with lengths above preselected one and data with lengths below the same, respectively. Moreover, the length of high-priority data may even be shorter than the length of low-priority data, if desired.

In the illustrative embodiment, a Bluetooth module receives 300 bytes of data or 100 bytes of data from a host, decides a priority order on the basis of the number of bytes or data length, and then determines the order of transmission in accordance with the result of decision.

More specifically, FIG. 1 shows a stack of protocols implemented by the wireless communication apparatus 10. It is to be noted that the portions of the protocol stack not directly relevant to the understanding of the present invention are not shown or described. In the following description, signals and data are designated by reference numerals attached to connections on which they are conveyed. The wireless communication apparatus 10 may be implemented as a personal computer or a cellular phone by way of example.

The protocol stack shown in FIG. 1 will be briefly described hereinafter. As shown, the protocol stack is generally made up of a host 12 belonging to the upper layer, a Bluetooth module 14 belonging to the lower layer and a USB/RS232C (Universal Serial Bus/Recommended Standard 232C) section 16 intervening between the two layers 12 and 14. The host 12 controls the Bluetooth module 14 and transmits and receives data to and from the Bluetooth module 14 via the USB/RS232C section 16 operable in accordance with USB or RS232C, which is a serial interface standard.

In the host 12, an application 18, an application program interface (API) 20, a TCP/IP (Transmission Control Protocol/Internet Protocol) 22, an RFCOMM (Radio Frequency COMMunications) 24, a logical link control layer 26 and an HCI driver 28 are stacked in a hierarchical structure. The application 18 may be a WWW (Word Wide Web) browser or a mailer by way of example. The application program interface 20 allows the application 18 to use the TCP/IP 22, RFCOMM 24 or similar protocol. The TCP/IP 22 is a protocol for the WWW browser or the mailer mentioned above while the RFCOMM 24 is a protocol for emulating a COM (Component Object Model) port included in a personal computer, e.g., an EIA-232 serial port. The logical link control layer 26 performs logical channel control, protocol multiplexing, packet disassembly or fragmentation as sometimes referred to, packet reassembly, and QoS control. The HCI driver 28 transmits and receives data to and from the Bluetooth module 14, which is lower layer, via the USB/RS232C section 16.

The Bluetooth module 14 includes a host controller interface (HCI) 30, a link manager layer 32, a baseband layer 34, and a physical layer 36 relating to radio frequency (RF). The host controller interface 30 transmits and receives data to and from the host or upper layer device 12 via the USB/RS232C section 16. The link manager 32 executes control relating to a communication link, i.e., connections and disconnections of a communication link. The baseband layer 34 provides a communication link and designates, switches or otherwise controls a transmission and receipt frequency. The physical layer 36 performs communications based upon the frequency hopping type of spread spectrum technology.

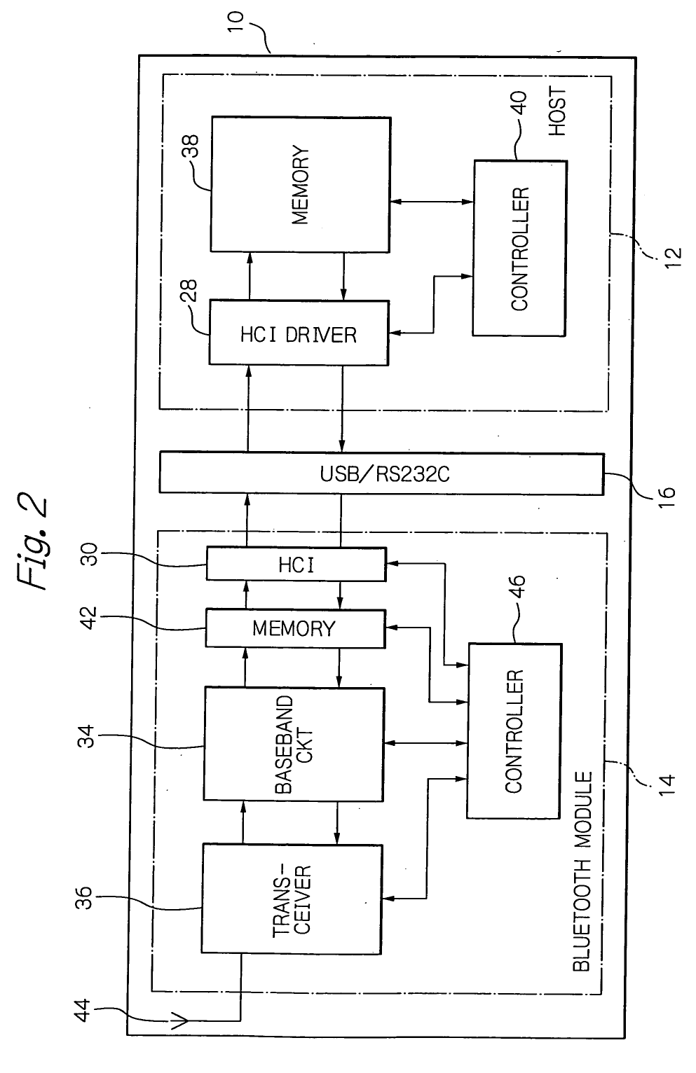

Reference will be made to FIG. 2 for describing a hardware configuration implementing the wireless communication apparatus 10 shown in FIG. 1. As shown, the host 12 includes a memory 38 and a controller 40 as well as the HCI driver 28. The memory 38 stores software for executing the application 18, application program interface 20, TCP/IP 22, RFCOMM 24 and logical link control layer 26. The controller 40 reads out the software stored in the memory 38 to execute the application 18, application program interface 20, TCP/IP 22, RFCOMM 24 and logical link control layer 26. For this purpose, the controller 40 causes the HCI driver 28 to transmit and receive data to and from the Bluetooth module 14.

On the other hand, the Bluetooth module 14 includes a memory 42, a controller 46, a transceiver 36 and an antenna 44 as well as the host controller interface 30 and baseband circuit or layer 34. The memory 42 stores software for implementing the link manager layer 32, FIG. 1. The transceiver 36 and antenna 44 constitute the physical layer 36, FIG. 1, in combination. The controller 46 reads out and executes the software stored in the memory 42 and controls the host controller interface 30, memory 42, baseband circuit 34 and transceiver 36.

In the illustrative embodiment, the applications overlying the logical link control layer 26, i.e., application 18, TCP/IP 22 and RFCOMM 24 and so forth each output particular data to be sent out to the logical link control layer 26. In response, the logical link control layer 26 divides the input data into pieces of data of a preselected size in accordance with a transmission priority order assigned to the application 18, TCP/IP 22, RFCOMM 24 and so forth. The logical link control layer 26 then generates HCI data packets containing a piece of data thus divided. Subsequently, the link manager layer 32 determines the size of the pieces of data contained in the HCI data packets on the basis of the length also contained in the HCI data packets, determines a transmission priority order in accordance with the size, and then sends out the data packets in accordance with the priority order thus determined.

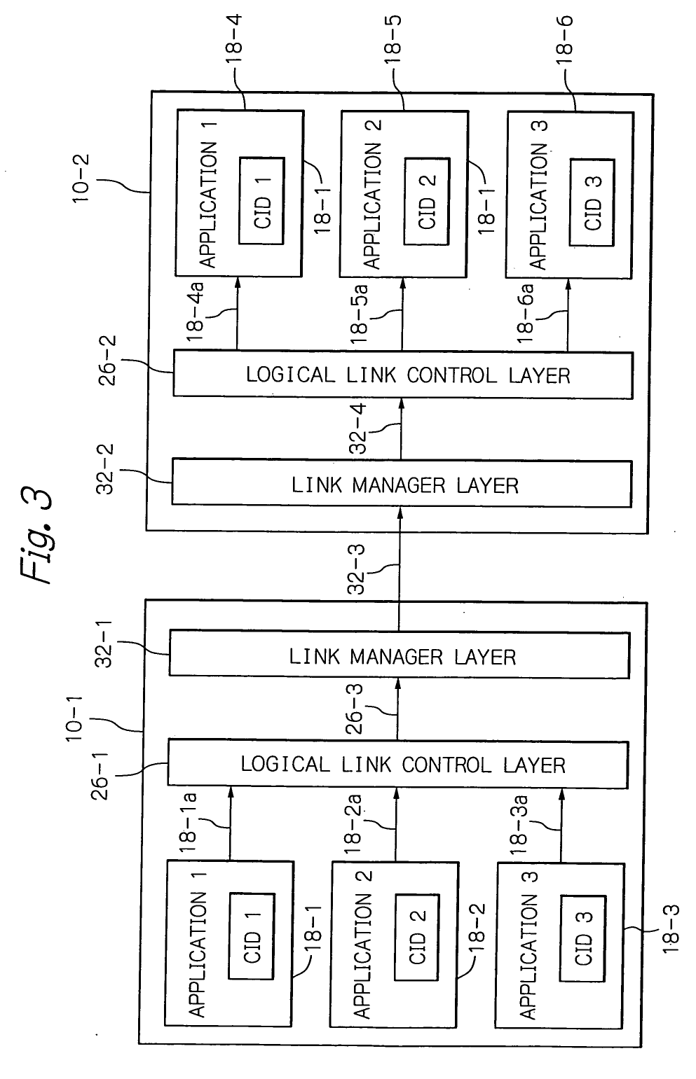

Why the link manager layer 32 of the illustrative embodiment is configured to determine the size of a piece of data on the basis of the length contained in the HCI packet and then determine a transmission priority order will be described with reference to FIG. 3 hereinafter. FIG. 3 shows two wireless communication apparatuses 10-1 and 10-2 based on the Bluetooth communication standard and illustrates the flow of data on the assumption that data are sent out from the apparatus 10-1 to the apparatus 10-2 by way of example. In FIG. 3, layers not directly relevant to the determination of a priority order are not shown.

As shown in FIG. 3, assume that applications 18-1, 18-2 and 18-3 (APPLICATIONS 1, 2 and 3, respectively) are included in the wireless communication apparatus or source 10-1 and respectively expected to send data to applications 18-4, 18-5 and 18-6 (APPLICATIONS 1, 2 and 3, respectively) included in the wireless communication apparatus or destination 10-2.

When any one of the applications 18-1, 18-2 and 18-3 included in the sending apparatus 10-1 sends out data to the corresponding application included in the receiving apparatus 10-2, the former identifies the latter on the basis of a channel identifier (CID). More specifically, the applications of the sending apparatus 10-1 designate respective channel identifiers and then output L2CAP data packets 18-1a, 18-2a and 18-3a, respectively, to a logical link control layer 26-1. The L2CAP data packets 18-1a, 18-2a and 18-3a each are a data unit containing a channel identifier.

For example, a channel identifier 1 (CID 1) is assigned to the applications 18-1 and 18-4. Likewise, a channel identifier 2 (CID 2) is assigned to the applications 18-2 and 18-5 while a channel identifier 3 (CID 3) is assigned to the applications 18-3 and 18-6.

The logical link control layer 26-1 distinguishes the plurality of applications to deal with on the basis of the channel identifier. On the other hand, the wireless communication apparatuses 10-1 and 10-2, based on the Bluetooth communication standard, use a connection handle for identifying actual physical connection to each other. More specifically, the Bluetooth standard prescribes that the layers underlying the logical link control layer 26 should identify a destination on the basis of a connection handle.

The logical link control layer 26-1 outputs to the HCI driver 28 just underlying it an HCI data packet 26-3, i.e., a data unit containing a connection handle. When the logical link control layer 26-1 outputs L2CAP data packets 18-1a, 18-2a and 18-13a respectively containing the channel identifies CID 1, CID 2 and CID 3 and meant for the same destination to the HCI driver 28, the layer 26-1 converts the L2CPA data packets 18-1a, 18-2a and 18-3a to HCI data packets 26-3 containing the same connection handle. Subsequently, a link manager layer 32-1 references the connection handle contained in the HCI data packets 26-3 to identify a destination. Further, the link manager layer 32-1 converts the HCI data packets 26-3 to transmission data 32-3 having a preselected format in accordance with the Bluetooth communication standard. The transmission data 32-3 are sent out to the receiving apparatus or destination 10-2 over a physical link 32-3 designated by the connection handle.

As stated above, the layers underlying the logical link control layer 26 do not use channel identifiers for the identification of data, but use only a connection handle. The layers underlying the logical link control layer 26 process data not containing channel identifiers also, as will be described later specifically. Further, a connection handle and a channel identifier are determined independently of each other because a connection handle and a channel identifier are used to identify a communication apparatus and an application, respectively, as stated earlier.

For the reasons stated above, the link manager layer 32 and successive layers, which actually perform communication processing, cannot identify an application by referencing a connection handle and therefore cannot identify data output from different applications to which the same connection handle is assigned, i.e., meant for the same communication apparatus. This is why conventional wireless communication apparatuses have been unable to send out different applications with different priorities, i.e., cannot guarantee QoS.

In the other communication apparatus or destination 10-2, the data 32-3 received from the communication apparatus or source 10-1 are input to a link manager layer 32-2. The link manager layer 32-2 converts the data 32-3 to HCI data packets 32-4 and delivers the HCI data packets 32-4 to a logical link control layer 26-2. The logical link control layer 26-2 produces the L2CAP data packets 18-1a, 18-2a and 18-3a meant for the applications 18-4, 18-5 and 18-6, respectively, from the HCI data packets 32-4, analyzes the channel identifiers CID 1, CID 2 and CID 3 of the L2CAP data packets 18-1, 18-2 and 18-3 and then sends out the data packets 18-1, 18-2 and 18-3 to the applications 18-4, 18-5 and 18-6, respectively.

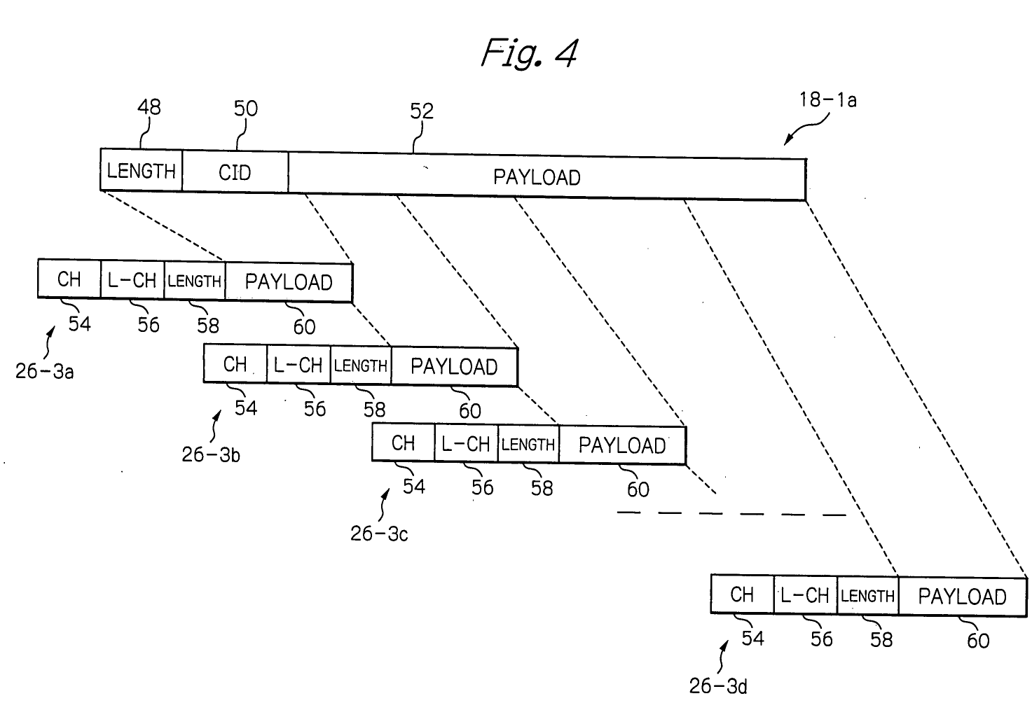

Reference will be made to FIG. 4 for describing how the logical link control layer 26-1 converts the L2CPA data packets 18-1a, 18-2a and 18-3a to the HCI data packets 26-3 containing the same connection handle and how the logical link control layer 26-2 produces the L2CAP data packets 18-4a, 18-5a and 18-6a from the HCI data packets 32-4. Such operations of the logical link control layers 26-1 and 26-2 are generally referred to as packet division or fragmentation and reconstruction, respectively. Also, packet division and reconstruction are sometimes collectively referred to as SAR (Segmentation and Reassembly).

FIG. 4 demonstrates a procedure in which the logical link control layer 26 divides, e.g., the L2CAP data packet 18-1a into the HCI data packets 26-3 containing the same connection handle. The L2CAP data packet 18-1a input from the application 18-1 to the logical link control layer 26 may have the maximum length of 64 kilobytes, as allowed by the Bluetooth communication standard. However, the length of data that the link manager layer 32 can send out to a destination is up to 339 bytes, as prescribed by the Bluetooth communication standard. Under the circumstances, as shown in FIG. 4, the logical link control layer 26 divides the entire L2CAP data packet 18-1a into HCI data packets 26-3a, 26-3b, 26-3c and 26-3d.

More specifically, the L2CAP data packet 18-1a consists of two bytes of length field 48, two bytes of CID field 50 and sixty-four or fewer kilobytes of payload or essential data 52. The length field 48 stores data representative of the size of the payload 52 in bytes while the CID field 50 stores the channel identifier CID 1 representative of the application 18-1 outputting the L2CAP data packet.

The HCI data packets 26-3a through 26-3d each consist of twelve bits of CH (Connection Handle) field 54, two bits of L-CH (Leading CH) field 56, nine bits of length field 58 and 300 or 100 bytes of payload or essential data 60. The CH field 54 stores the connection handle common to the HCI data packets 26-3a through 26-3d. The length field 58 stores data representative of the size of the payload 60 in bytes.

The L-CH field 56 stores data “10” in the case of the leading HCI data packet 26-3a or stores data “Ol” in the case of the other HCI data packets 26-3b, 26-3c and 26-3d following the HCI data packet 26-3a. More specifically, the data “10” and “Ol” respectively indicate that the HCI data packet 26-3a is, among the HCI data packets derived from the same L2CAP data packet 18-1a, the leading HCI data and that the other HCI data packets 26-3b, 26-3c and 26-3d are not the leading packet. It should be noted that when the amount of data stored in the L2CAP data packet 18-1a is relatively small, only the leading HCI data packet 26-3a may be produced from the packet 18-1a, i.e., the other HCI data packets 26-3b, 26-3c and 26-3d may be absent.

It should also be noted that the size of the data stored in the last HCI data packet 26-3d could sometimes be less than 300 bytes or less than 100 bytes. Because the size of the HCI data packet 26-3d must be 300 bytes or 100 bytes in the illustrative embodiment, dummy data for making up for the shortage are added to the HCI data packet 26-3d. However, the dummy data do not have to be a special character code that distinguishes the essential or original data from the dummy data. This is because the logical link control layer 26-2 on the receiver side can reassemble the received HCI data packets 26-3a through 26-3d to reconstruct the L2CAP data packet 18-1a, as opposite to FIG. 4, and reference the length 48 contained in the above L2CAP data packet 18-1a, the length of the entire data to be received being seen thereby. Based upon that information, it is possible to discard only the dummy data thus added from the essential or user data. The dummy data may include a specific value, such as nulls, with which all vacant bytes are filled up.

The procedure in which the logical link control layer 26-2 reassembles each of the L2CAP data packets 18-4a, 18-5a and 18-6a from the HCI data packets 26-3 is opposite to the procedure in which the logical link control layer 26-1 converts the L2CAP data packet 18-1a to the HCI data packet 26-3 containing the same connection handle.

Now, only a single logical link control layer is connectable to a single Bluetooth module while any number of applications are allowed to access the single logical link control layer, so that a plurality of CIDs exist. For example, assuming that one Bluetooth module is connected to another Bluetooth module, then communication at the level of the logical link control layers of the two modules is held between the two logical link control layers. It follows that in the specific condition shown in FIG. 3, three different applications share two logical link control layers. Further, because a single Bluetooth module allows seven physical links, i.e., seven other Bluetooth modules to be connected thereto at the same time, up to seven connection handles can exist in total with a single connection handle for a single terminal in communication.

The illustrative embodiment will be described on the assumption that a plurality of different applications send out data to a terminal provided with a single connection handle, i.e., the same terminal, and that each application sends out data with a particular degree of priority. It is to be noted that when a plurality of applications send out data to terminals provided with different connection handles, i.e., different terminals, the priority order can be determined on a connection handle basis.

More specifically, in the illustrative embodiment, the logical link control layer is provided with a priority and a non-priority data buffer assigned to priority data and non-priority data, respectively. On receiving data with a priority connection handle and data with a non-priority connection handle, the logical link control layer stores the former and the latter in the priority data buffer and non-priority data buffer, respectively, and then preferentially outputs the data stored in the priority data buffer to the link manager layer.

As for data provided with the same connection handle, the logical link control layer preferentially outputs the data of a priority application to the link manager layer. Further, when a plurality of data provided with the same connection handle include data different in length from the other data, the link manager layer preferentially sends out data of higher priority, i.e., longer data. In addition, the link manager layer preferentially sends out the data provided with the priority connection handle.

The illustrative embodiment will be described more specifically with reference again made to FIG. 1. In the following description, assume that a connection for communication based on the Bluetooth communication standard has already been established by a procedure according to the Bluetooth communication standard, so that communication terminals to communicate with each other are ready to transmit data to each other. The communication terminals have therefore acquired information relating to each other's connection handles and channel identifiers.

In the protocol stack shown in FIG. 1, let the application 18, TCP/IP 22 and RFCOMM 24, i.e., applications overlying the logical link control layer 26 of the host 12 be collectively referred to as applications. Then, the applications can issue a QoS command in accordance with the Bluetooth communication standard before sending data. The QoS command simply requests for QoS in relation to a physical link or connection handle and does not fix a priority order on pieces of data having the same connection handle as in the illustrative embodiment. By the QoS command, a physical link or connection handle with priority is identified. QoS relating to the illustrative embodiment will be referred to as a QoS guarantee in distinction from the conventional QoS particular to the Bluetooth communication standard.

When any one of the applications requests for a QoS guarantee in relation to data to output, i.e., requests for preferential processing of data to output, the application issues the QoS command stated above, and thereafter uses a vendor command to output a QoS guarantee request to the logical link control layer 26. The other applications, not requesting for a QoS guarantee, do not output the QoS guarantee request to the logical link control layer 26. It is to be noted that the term “vendor command” refers to a command not prescribed by the Bluetooth communication standard.

In response to the QoS guarantee command, the logical link control layer 26 uses the vendor command to report to the link manager layer 32 the number of degrees of priority and the lengths of data each corresponding to particular one of the degrees of priority, i.e., the sizes of payloads of HCI data packets. The link manager layer 32 can therefore recognize the priority order of the data packets on the basis of the lengths of data. Further, when the QoS command from any one of the applications is input to the logical link control layer 26, the layer 26 reports a priority physical link or connection handle to the link manager 32 by using the QoS command.

In the specific illustrative embodiment, the number of degrees of priority is two, i.e., “high” and “low” while the lengths of data corresponding to “high” and “low” are 300 bytes and 100 bytes, respectively; the longer the data, the higher the priority, as stated previously.

Assume that any one of the applications having the same connection handle outputs the QoS guarantee request to the logical link control layer 26 (referred to as requesting application hereinafter), but the other applications do not output it (referred to as non-requesting applications hereinafter). Then, as shown in FIG. 4, the logical link control layer 26 segments an L2CAP data packet received from the requesting application into a plurality of HCI data packets each having a length of 300 bytes. At the same time, the logical link control layer 26 segments an L2CAP data packet output from each non-requesting application into a plurality of HCI data packets each having a length of 100 bytes. Subsequently, the logical link control layer 26 sends out the two kinds of HCI data packets to the HCI driver 28.

In the illustrative embodiment, when a single L2CAP data packet input to the logical link control layer 26 from any one of the applications at the time of transmission contains data of a size or length greater than 300 or 100 bytes, the logical link control layer 26 segments the L2CAP data packet into a plurality of HCI data packets each having a length of 300 or 100 bytes or less. However, when the length of data contained in the above single L2CAP data packet is smaller than 300 or 100 bytes, the logical link control layer 26 does not segment the L2CAP data packet into a plurality of HCI data packets.

The HCI data packets are fed from the logical link control layer 26 to the link manager layer 32 via the HCI driver 28, USB/RS232C section 16 and host controller interface 30. In response, the link manager layer 32 first examines the connection handle 54 of each HCI data packet and then examines, if the connection handle 54 expected to transfer the data packet is provided with QoS, the length 58 of the HCI packet. If the length of the HCI packet represented by the length 58 is 300 bytes, then the link manager layer 32 writes the HCI packet in the priority data buffer mentioned earlier. By contrast, if the length of the HCI packet is 100 bytes, then the link manager layer 32 writes the HCI packet in the non-priority data buffer. Data stored in the priority data buffer is sent before data stored in the non-priority data buffer without exception.

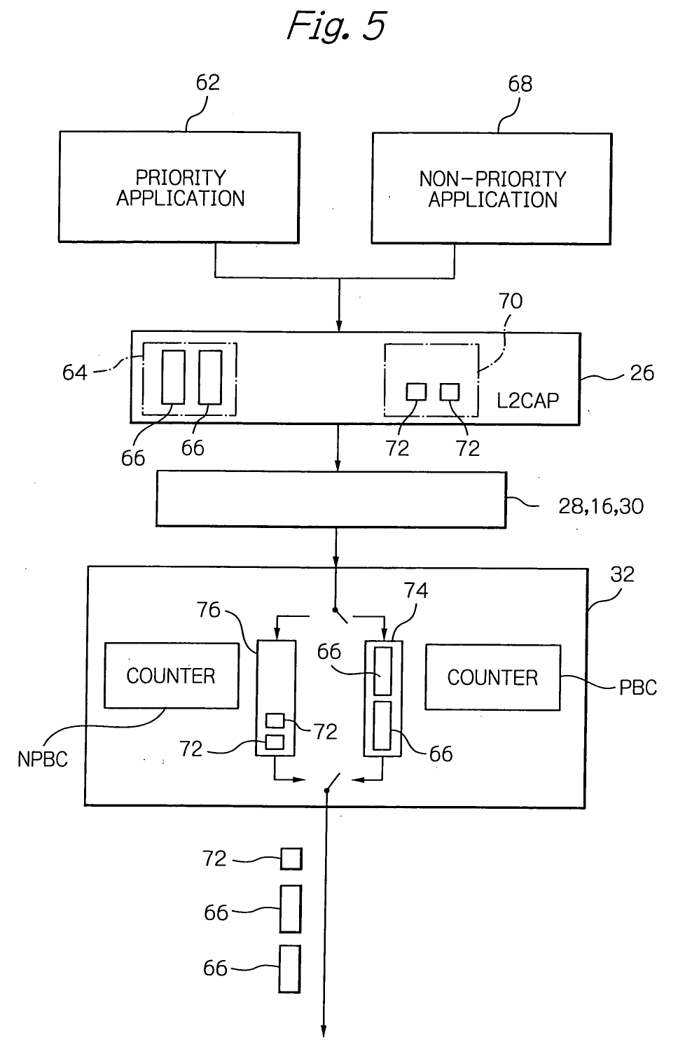

The above procedure will be described more specifically with reference to FIG. 5. As shown, the logical link control layer 26 segments an L2CAP data packet 64 received from a requesting application 62 into a plurality of HCI data packets 66 each being 300-byte long. Also, the logical link control layer 26 segments an L2CAP data packet 70 received from a non-requesting application 68 into a plurality of HCI data packets 72 each being 100-byte long. The logical link control layer 26 then delivers the HCI data packets 66 and 72 to the link manager layer 32 via the HCI driver 28, USB/RS232C section 16 and host controller interface 30.

The link manager layer 32 includes data buffers 74 and 76 each being assigned to a particular data length in order to practice a scheduling method based on a data length. The data buffers 74 and 76 are respectively a priority transmission buffer assigned to packets to be sent out with priority and a non-priority transmission buffer assigned to the other packets.

Assume that an HCI data packet has a connection handle not requesting for QoS or that an HCI data packet has a connection handle requesting for QoS, but the non-priority application 68 outputting the HCI packet does not request for a QoS guarantee. Such an HCI data packet 72 is written into the non-priority transmission buffer 76. On the other hand, an HCI data packet 66 having a connection handle with requesting for a QoS guarantee is written into the priority transmission buffer 74. The priority transmission buffer 74 and non-priority transmission buffer 76 should preferably be provided in combination on a connection handle basis.

If the connection handle with requesting for a QoS guarantee and the connection handle without requesting for it exist together at the time of data transmission, then the link manager layer 32 preferentially sends out the HCI data packet with the connection handle with requesting for a QoS guarantee before the HCI data packet with the connection handle without requesting for it. For the sake of simplicity of description, FIG. 5 shows a specific case wherein only a single connection handle exists and requests for QoS, and a priority application requesting for a QoS guarantee and a non-priority application not requesting for it send data at the same time via the connection handle.

The link manager layer 32 references a length contained in the HCI data packet to determine the size of the HCI data packet for thereby determining whether or not the HCI data packet is output from the priority application 62 requesting for a QoS guarantee. The link manager layer 32 then stores the HCI data packet in the priority transmission buffer 74 if the packet size is 300 bytes or stores it in the non-priority transmission buffer 76 if the packet size is 100 bytes. The link manager layer 32 sends out the data stored in the priority transmission buffer 74 before the data stored in the non-priority transmission buffer 76 without exception.

The prerequisite with the above procedure is that the transmission of the data stored in the non-priority transmission buffer 76 be not obstructed by the preferential transmission of the data stored in the priority transmission buffer 74. Stated another way, the transmission of the data stored in the non-priority transmission buffer 76 must be started when the data stored in the priority transmission buffer 74 are sent out by a preselected amount. To this end, the illustrative embodiment additionally includes counters PBC and NPBC which count the amount of data transmitted from the priority transmission buffer 74 and non-priority transmission buffer 76, respectively.

The logical link control layer 26 informs, beforehand, the link manager layer 32 of an amount of data by which the data stored in the priority transmission buffer 74 should be sent out relative to the capacity of the buffer 74 before the start of transmission of the data stored in the non-priority transmission buffer 76.

As stated above, the link manager layer 32 distributes the data received from the logical link control layer 26 to the priority transmission buffer 74 and non-priority transmission buffer 76 and preferentially sends out the data stored in the buffer 74 before the data stored in the buffer 76.

In the illustrative embodiment, it is likely that the priority and non-priority applications 62 and 68, respectively, continuously output data to the logical link control layer 26, so that the logical link control layer 26, processing the above data, continuously delivers the resulting data to the link manager layer 32. In such a case, the link manager layer 32 alternately repeats storage processing for selectively storing the data in the two transmission buffers 74 and 76 and transmission processing for sending out the data thus stored. Various schemes are available for switching the storage processing and transmission processing, as will be described hereinafter.

For example, there may be executed a procedure that interrupts, on handling a preselected amount of data by the storage processing, the storage processing and starts the transmission processing and then interrupts, on handling a preselected amount of data by the transmission processing, the transmission processing and again starts the storage processing. Alternatively, a timer, not shown, may be used to replace the storage processing and transmission processing with each other at preselected intervals.

Another alternative scheme is such that the link manager layer 32 is mounted as one of tasks assigned to an RTOS (Real Time Operating System) while an LC (Link Controller) for sending data is mounted as another task. In this case, the link manager layer 32 starts distributing data as soon as it receives data from the logical link control layer 26. When the data are stored in the priority and non-priority transmission buffers 74 and 76, the link controller is enabled to start sending out the data, the data stored in the buffer 74 being sent out first. In practice, those two tasks operate substantially at the same time.

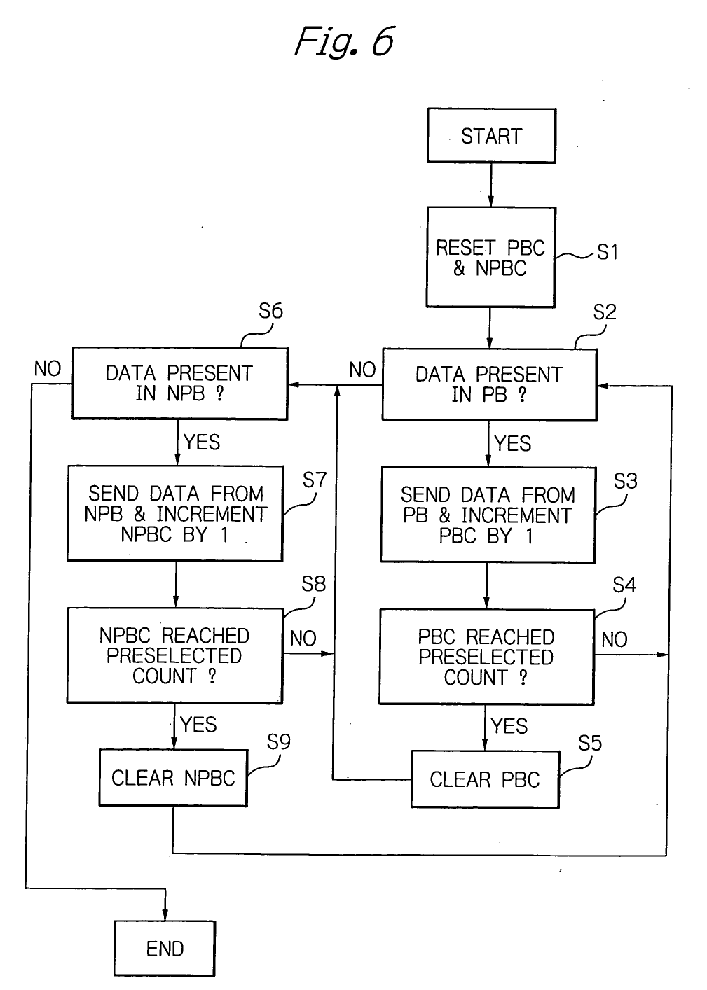

As for the transmission processing, after a preselected amount of data has been sent out from the priority transmission buffer 74 relative to the capacity of the buffer 74, data in the non-priority buffer 76 starts being sent out, as stated previously. FIG. 6 demonstrates a specific procedure for executing such an operation. The procedure to be described hereinafter ends when data are absent in the priority transmission buffer (PB) 74 and in the non-priority transmission buffer (NPB) 76 as well. The counters PBC and NPBC mentioned earlier count data sent from the priority and non-priority transmission buffers 74 and 76, respectively. The counters PBC and NPBC both are implemented by so-called FIFO (First-In First-Out) buffers.

As shown in FIG. 6, the procedure begins with a step S1 of resetting the counters PBC and NPBC by inputting “0 (zero)”. Subsequently, whether or not data are present in the priority transmission buffer 74 is determined. If the answer of this decision is positive, YES, then 300 bytes of data are sent out from the priority transmission buffer 74, i.e., a single data packet is sent out by one time of transmission while the counter PBC is incremented by 1 (one) (step S3). The step S3 is followed by a step S4 of determining whether or not the counter PBC has reached a preselected count (step S4). If the answer of the step S4 is negative, NO, then the procedure returns to the step S2. If the answer of the step S4 is YES, then the transmission of data from the priority transmission buffer 74 is interrupted, and the counter PBC is again rest to “0” (step S5).

If the answer of the step S2 is NO, meaning that data are absent in the priority transmission buffer 74, or after the step S5, whether or not data are present in the NPB 76 is determined (step S6). If the answer of the step S6 is NO, then the procedure ends. If the answer of the step S6 is YES, then 100 bytes of data are sent out from the NPB 76, i.e., a single data packet is sent out by one time of transmission, and the counter NPBC is incremented by 1 (step S7). Subsequently, whether or not the counter NPBC has reached a preselected count is determined (step S8). If the answer of the step S8 is NO, then the procedure returns to the step S6. If the answer of the step S8 is YES, then the transmission of the data from the NPB 76 is interrupted. Subsequently, the counter NPBC is reset to “0” (step S9). After the step S9, the step S2 and successive steps are repeated.

If desired, hardware may be used to automatically monitor the transmission of data from the priority transmission buffer 74 and start, when a preselected amount of data is sent out from the buffer 74, the transmission of data from the non-priority transmission buffer 26 by interrupt processing.

When the link manager 32 outputs data to the underlying layers, it converts the HCI data packets to data packets having another format based on the Bluetooth communication standard.

A receiving apparatus in accordance with the present invention executes a procedure opposite to the procedure described with reference to FIG. 5. More specifically, in the receiving apparatus, the link manager layer 32 produces HCI data packets from data packets received from the transmitting apparatus of FIG. 5. Subsequently, the link manager layer 32 determines a priority order on the basis of lengths 58 contained in the HCI data packets, selectively stores the data of each HCI data packet in the priority transmission buffer 74 or the non-priority transmission buffer 76, and then delivers the above data to the logical link control layer 26 via the host controller interface 30, USB/RS232C section 16 and HCI driver 28.

The logical link control layer 26 reassembles the HCI data packets received from the link manager layer 32 to thereby reconstruct the L2CAP data packets and then transfers each L2CAP data packet to a particular application designated by a channel identifier contained in the L2CAP data packet.

As stated above, the link manager layer is capable of recognizing the lengths of HCI data packets and therefore the degrees of priority matched one-to-one to the lengths. It is therefore possible to schedule the transfer of data packets in accordance with the priority order. At this instant, a priority and a non-priority transmission buffer, included in the link manager layer, insure the transmission of data packets scheduled by the link manager layer in accordance with the priority order, easily realizing services with QoS guarantees. Further, by adequately setting vendor commands or monitoring hardware, it is possible to send out a preselected amount of priority packets and then send out non-priority data packets for thereby obviating the delay of transfer of non-priority data packets.

While the illustrative embodiment is applied to communication protocols according to the Bluetooth communication standard, the present invention is similarly applicable to other communication protocols unable to provide a data packet with a flag representative of a priority order.

The illustrative embodiment has been shown and described as determining a transmission/receipt priority order on the basis of the length of data. Alternatively, a priority order as to processing of data may be determined in accordance with the length of data. Such processing may be one not directly relating to transmission or receipt, e.g., data display processing.

The entire disclosure of Japanese patent application No. 2004-071905 filed on Mar. 15, 2004, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

1. A method of transmitting data to be transmitted between a plurality of terminals, comprising:
a first step of segmenting data to be transmitted into pieces of data each having a preselected size, which is determined in accordance with a priority order required of the data to be transmitted as to transmission, and generating data units each containing a particular one of the pieces of data;
a second step of determining a priority order as to transmission on a basis of the size of the data contained in the data units; and
a third step of transmitting the data units in accordance with the priority order determined in said second step.

2. The method in accordance with claim 1, wherein the data units comprised at a packets prescribed by a Bluetooth communication standard.

3. The method in accordance with claim 2, wherein said first step comprises generating a plurality of data packets having a same connection handle based on the Bluetooth communication standard,
said second step comprising determining a priority order as to transmission on a basis of a size of data contained in each of the plurality of data packets,
said third step comprising transmitting the plurality of data packets in accordance with the priority order determined in said second step, whereby, among the plurality of data packets having the same connection handle, data packets with higher priority are preferentially transmitted.

4. The method in accordance with claim 1, wherein said second step comprises storing, after the priority order has been determined, the data units in one of a plurality of data buffers each being assigned to a particular degree of priority,
said third step comprising preferentially transmitting the data units stored in one of the plurality of data buffers assigned to higher priority.

5. A method of receiving data to be transmitted between a plurality of terminals, comprising:
a first step of receiving data units transmitted by a sequence of steps of segmenting data to be transmitted into pieces of data each having a preselected size, which is determined in accordance with a priority order required of the data to be transmitted as to transmission, generating data units each containing a particular one of the pieces of data, determining a priority order as to transmission on a basis of the size of the data contained in the data units, and transmitting the data units in accordance with the priority order;
a second step of determining, based on the size of the data contained in the data units received, a priority order as to processing of the data units; and
a third step of reconstructing the data to be transmitted from the plurality of received data units in accordance with the priority order determined in said second step.

6. An apparatus for transmitting data to be transmitted between a plurality of terminals, comprising:
a data generator for segmenting data to be transmitted into pieces of data each having a preselected size, which is determined in accordance with a priority order required of the data to be transmitted as to transmission, and generating data units each containing a particular one of the pieces of data;
a data transmitter for determining a priority order as to transmission on a basis of the size of the data contained in the data units, and transmitting the data units in accordance with the priority order.

7. The apparatus in accordance with claim 6, wherein the data units comprise data packets prescribed by a Bluetooth communication standard.

8. The apparatus in accordance with claim 7, wherein said data generator generates a plurality of data packets having a same connection handle based on the Bluetooth communication standard,
said data transmitter determining a priority order as to transmission on a basis of a size of data contained in each of the plurality of data packets, and transmitting the plurality of data packets in accordance with the priority order, whereby, among the plurality of data packets having the same connection handle, data packets with high priority are preferentially transmitted.

9. The apparatus in accordance with claim 6, wherein said data transmitter stores, after the priority order has been determined, the data units in one of a plurality of data buffers each being assigned to a particular degree of priority and preferentially transmits the data units stored in one of said plurality of data buffers assigned to higher priority.

10. An apparatus for receiving data to be transmitted between a plurality of terminals, comprising:
a data receiver for receiving data units transmitted by a sequence of steps of segmenting data to be transmitted into pieces of data each having a preselected size, which is determined in accordance with a priority order required of the data to be transmitted as to transmission, generating data units each containing a particular one of the pieces of data, determining a priority order as to transmission on a basis of the size of the data contained in the data units, and transmitting the data units in accordance with the priority order;
a data reconstructing circuit for determining, based on the size of the data contained in the data units received, a priority order as to processing of the data units and reconstructing the data to be transmitted from the plurality of received data units in accordance with the priority order.

11. A communicating method using data to be transmitted between a plurality of terminals, comprising the steps of:
segmenting data to be transmitted into pieces of data each having a preselected size, which is determined in accordance with a priority order required of the data to be transmitted as to processing and generating data units each containing a particular one of the pieces of data;
determining a priority order as to processing on a basis of the size of the data contained in the data units generated; and
processing the data units in accordance with the priority order determined.
